(19) United States
(12) Patent Application Publication
(10) Pub. No.: US 2004/0091593 A1
(43) Pub. Date: May 13, 2004

(54) Fish egg or milt product having extended tasting period

(75) Inventors: Kenichi Hiraoka, Onomichi-Shi (JP); Yukie Hiraoka, Onomichi-Shi (JP); Shinya Hiraoka, Onomichi-Shi (JP); Tomomi Hiraoka, Onomichi-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JAPANTECHNO LTD., CO., Onomichi-Shi (JP)

(21) Appl. No.: 10/607,049

(22) Filed: Jun. 27, 2003

Related U.S. Application Data
(63) Continuation of application No. PCT/JP01/02342, filed on Mar. 23, 2001.

(30) Foreign Application Priority Data
Dec. 27, 2000 (JP) 2000-397336

(51) Int. Cl. A23B 5/00

(52) U.S. Cl. 426/330.1

(57) ABSTRACT

The present invention relates to a process for treating fresh fish eggs including those in the form of ovary or hard roe such as salted roes of salmons or trouts, salted roes divided into the respective eggs, and fresh milt or soft roe. Further, the present invention relates to fresh hard roe and milt products obtained by the process. The present invention also relates to a fresh fish egg or milt product having an extended tasting period or an enhanced commercial value. The present invention also provides hard roes or eggs of salmons or the like caught at a late time or off-season, which have been considered to have no commercial value, as commercially valuable fresh fish egg products. According to the present invention, fresh fish eggs or milt materials may be treated with an aqueous alkali solution and then the aqueous alkali solution may remain on the treated fish eggs or milt.

### CROSS-REFERENCE TO RELATED APPLICATIONS

The present application claims priority to PCT International Application Number PCT/JP01/02342, filed Mar. 23, 2001, and Japanese Patent Application Number 2000-397336, filed Dec. 27, 2000. The entire contents of both applications are incorporated herein by reference.

### BACKGROUND OF INVENTION

1. Field of the Invention

The present invention relates to a process for treating fresh fish eggs including those in the form of ovary or hard roe such as salted roes of salmons or trouts, salted roes divided into the respective eggs, and fresh milt or soft roe. Further, the present invention relates to fresh hard roe and milt products obtained by the process. The present invention also relates to a fresh fish egg or milt product having an extended tasting period or an enhanced commercial value. The present invention also provides hard roes or eggs of salmons or the like caught at a late time or off-season, which have been considered to have no commercial value, as commercially valuable fresh fish egg products. According to the present invention, fresh fish eggs or milt materials may be treated with an aqueous alkali solution and then the aqueous alkali solution may remain on the treated fish eggs or milt. Finally, the solution may be washed off or neutralized the treated fish eggs or milt.

2. Discussion of the Background

As salmon grow, their salmon eggs will change from ovary or hard roe composed of eggs connected with each other to eggs separated from each other. For example, in Hokkaido, the eggs are in the form of ovary wherein the rate of eggs which are separated into respective eggs is small, during the harvesting season from September to the end of October September to December is known as the Miyagi Prefecture. In this season, commercially valuable salted roes of salmons or trouts, e.g. Sujiko, or those divided into the respective eggs thereof, e.g. Ikura, are obtained. The ovary may be taken from the ventral side of each salmon, washed with fresh water in a short period of time to remove stains such as the blood and mucus therefrom. Thereafter, the ovary may be placed on a drainboard to drain it and then preserved in salt by a Tanazuke Method (e.g. Furishio-zuke) or Hakogiri Method (e.g. Tateshio-zuke) to produce the salted roes.

Ikura may be produced by the following method: The ovaries, taken from fresh salmons within 6 hours after the fishing, may be washed with water to remove stains such as the blood and mucus therefrom. They may be drained and then separated into the respective eggs, which may be immersed in saturated aqueous salt solution under occasional stirring for about 10 to 20 minutes. The eggs may be drained and then kept at around 4° C. in a refrigerator.

However, after the harvest season, e.g. after the middle of November, salmon are called “Buna (e.g. beech) salmon” and this time is usually too late for obtaining Sujiko and Ikura. The eggs of the beech salmon caught in this season have been grown to form the large eggs separated from one another. The respective eggs are covered with double membranes and, therefore, the membrane is thicker in this season, as compared with the case wherein the surface of each egg is covered with a thin membrane when they are present in the form of ovaries. Thus, the eggs are tough and called “Ping-Pong balls” in this season and, even when they are dropped from a height of about 1 m, they are not broken but bound like rubber balls.

Because of the toughness of the eggs like rubber balls, they are not easily bitten with the teeth and they are moved in the mouth. Thus, they are valueless and not enjoyable as the delicious food. This fact also applies to ovaries and eggs of trouts.

For the reasons described above, salmon eggs obtained in this season could not be used for preparing Ikura and they may be thrown away or used as fish foods.

Sujiko and Ikura have only a short period of tasting time and they have to be eaten as early as possible. When they are stored for a long period of time, the membrane of the eggs is broken and the fluid flows out of the eggs to deform each egg. As a result, the appearance of the eggs becomes unattractive and they have no commercial value. Milt, i.e. soft roes, also have only a short period of tasting time and it is demanded that they should be kept fresh and eaten tastily for a long period of time, so as to enhance their commercial value.

### DETAILED DESCRIPTION OF THE INVENTION

The present inventor has assiduously conducted investigations to solve the foregoing problems. Consequently they have obtained the following various findings in order to obtain the object of the present invention, such as to provide fish egg or milt products having an elongated period of tasting time or an enhanced commercial value.

Another object of the present invention is to provide enhanced commercial value to ovaries or eggs of salmons and the like caught at a late time, which have been considered to have no commercial value. Such product may be commercially valuable fresh fish egg products.

After intensive investigations made for the purpose of attaining the above-described objectives, the present inventor has found that the objectives may be attained by treating fresh ovaries or fish eggs or milt taken out of fishes with an aqueous alkali solution. Further, the aqueous alkali solution remaining on the treated fish eggs or milt may be washed off or neutralized. The present invention has been completed on the basis of this finding.

The present invention also relates to a treatment that can be employed not only for ovaries and eggs (e.g. eggs) of salmons and trouts, but also for other fishes. Examples of such other fishes may be herring and mullet. The present invention also relates to a treatment of the milt of various fishes. The present invention has been accomplished on the basis of these findings.

Fish that can be treated by the present invention include those generally used for producing roe products thereof. Examples of such fish may include salmon, trout, herrings, codfish, mullet, striped mullet, and flying fish. Examples of fish the soft roes or milt of which are usable may include salmon, globefish, codfish, and herring.

In the present invention, the eggs or milt materials may be taken out of the fishes immediately after harvesting on a fishing boat in the ocean or the like or after the storage in frozen or chilled state and thawing. It is most preferred that those caught on a boat are immediately treated in situ. The sooner the removal of the eggs or milt from the fresh fish, the more fresh the eggs or milt materials and, as a result, the longer the tasting time thereof lasts.

After a fish dies, rotting starts on the surface thereof and in the internal organs. The eggs and milt materials located adjacent to the rotting internal organs also gradually rot after the death of the fish. The fish body contaminated by miscellaneous germs originally kept in the fish body is kept from rotting the fish while the fish is alive. It is considered, however, that after the fish dies, the germs start to propagate and rotting would start. Thus, when fish eggs or milt materials are taken out of the fish and left untreated, they gradually rot. Therefore, to extend the tasting time, it is very important to take out the eggs or milt materials from as fresh as possible fish and also to treat them as immediately as possible according to the present invention.

It is considered that such miscellaneous germs may be killed or removed by the treatment with an aqueous alkali solution according to the present invention. After the treatment, the fresh eggs or milt materials can be kept as they are for an elongated period of tasting time. In addition, various effects that will be described below can be obtained by the treatment of the present invention.

In the present invention, the fish eggs or milt materials taken out of fishes may be treated in an aqueous alkali solution. In the treatment, the fish eggs or milt materials may be immersed in the aqueous alkali solution or this solution is sprayed on them.

However, any form of application of the aqueous alkali solution to the fish eggs or milt materials may be utilized.

The aqueous alkali solutions usable in the present invention may be prepared by various methods. Although the method of preparation is not restricted, a preferred preparation is performed by dissolving an alkali in water. The alkalis are various so far as they can be dissolved in water to produce an alkaline solution. Examples of the alkalis may include calcium oxide, sodium hydroxide, potassium hydroxide, calcium hydroxide, disodium hydrogenphosphate, sodium phosphate, dipotassium hydrogenphosphate, potassium phosphate, diammonium hydrogenphosphate, sodium polyphosphate, potassium polyphosphate, calcium phosphate, magnesium carbonate, ammonium carbonate, sodium carbonate, potassium carbonate, calcium carbonate, sodium hydrogencarbonate and potassium hydrogencarbonate. These alkalis may be used alone or in the form of a mixture thereof. The alkalis easily available on the market are calcium carbonate and sodium carbonate and are thus most preferable.

In this treatment, the fish eggs or milt materials immersed in the aqueous alkali solution may or may not be frozen immediately thereafter. Further, the subsequent washing with water or neutralization may be conducted by immersing them in water or an acidic solution when they are thawed thereafter. For example, they may be thawed in a factory after transporting them in the frozen state to the factory.

The pH of the aqueous alkali solution is higher than 7.0. For example, a high pH value is desirable for the rapid treatment. pH value is usually 7.5 to 13.0, preferably 8.5 to 13.0 and particularly preferably 9.5 to 12.0. The pH may be 8.0, 9.0, 9.5, 10, 10.5, 11, 11.5, 12.5, 13.5, and 14, including all ranges and subranges therein.

The period of time for the treatment with the aqueous alkali solution usually varies depending on the treatment temperature. The treatment time may be from 1 minute to 24 hours, preferably 15 minutes to 1 hour. The treatment time may be 2 minutes, 5 minutes, 10 minutes, 20 minutes, 30 minutes, 40 minutes, 50 minutes, 1.5 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, and 23 hours, including all ranges and subranges therein.

The treatment temperature is usually 0 to 10° C., preferably 0 to 5° C. When the treatment temperature is below 0° C., a longer treatment time is required, however, the fish eggs or milt is scarcely contaminated with the miscellaneous germs. On the contrary, when the treatment temperature is above 10° C., the denaturation or deterioration of protein in the fish eggs or milt is accelerated to cause a problem of the deformation of them. The treatment temperature may be 0.5, 1, 2, 3, 4, 6, 7, 8, and 9° C., including all ranges and subranges therein.

If necessary, saccharides and salts may be incorporated into the aqueous alkali solution for the purpose of improving the penetration of the solution into the eggs or milt materials. Although all types of salts may be used, an example of a salt is sodium chloride. Although all types of saccharides may be used, examples reducing maltose, sorbitol and sucrose.

The fish eggs or milt materials thus treated with the alkali may be washed with water to remove the aqueous alkali solution from the surfaces of them or they may be neutralized directly or after an optional treatment.

The period of time for washing with water, which varies depending on the period of time for the alkali treatment, is usually 1 minute to 24 hours, preferably 30 minutes to 3 hours. The washing time may be 2 minutes, 5 minutes, 10 minutes, 20 minutes, 40 minutes, 50 minutes, 1 hour, 1.5 hour, 2 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, and 23 hours, including all ranges and subranges therein.

The fish eggs or milt materials can be washed with tap water or in a salt water having a concentration of from 1 to 6%, preferably 1 to 4%. The latter case is preferred because the fish eggs or milt materials treated with the salt water are firm. The concentration of salt in the water may be 1.5, 2, 2.5, 3, 3.5, 4.5, 5, and 5.5%, including all ranges and subranges therebetween.

The neutralization treatment can be conducted by many methods. Examplified methods include, but is not limite to, spraying the acidic solution over the materials treated with the alkali or by immersing the materials in the acidic solution.

All types of acidic solutions may be used. Examples of acidic solutions include aqueous solutions of inorganic acids such as hydrochloric acid, sulfuric acid and nitric acid and organic acids such as acetic acid, sulfonic acid and citric acid. Preferred acids are acetic acid and citric acid.

When the acidic solution is to be used for the spraying, pH of the solution is, for example, 4.0 to 6.6, preferably 5.0 to 6.5. The pH of the acidic solution when spraying may be 4.1, 4.2, 4.5, 4.7, 4.9, 5.1, 5.2, 5.5, 5.7, 5.9, 6.0. 6.1, 6.2, and 6.4, including all ranges and subranges therein.

When the acidic solution is to be used for the immersion, pH of the solution is, for example, 4.0 to 6.8, preferably 5.5 to 6.5. The pH of the acidic solution when immersing may be 4.1, 4.2, 4.5, 4.7, 4.9, 5.1, 5.2, 5.5, 5.7, 5.9, 6.0.6.1, 6.2, 6.3, 6.4, 6.6 and 6.7, including all ranges and subranges therein.

The materials can be neutralized in the acidic salt water. In such a case, the concentration of the salt water is, for example, 1 to 10% by mass, preferably 3 to 8% by mass. The concentration of the salt water may be 1.5, 2, 2.5, 3, 3.5, 4.5, 5, 5.5, 6., 6.5, 7, 7.5, 8, 8.5, 9, and 9.5%, including all ranges and subranges therein. The neutralization temperature is preferably in the range of about 5 to 15° C. The neutralization temperature may be 6, 7, 8, 9, 10, 11, 12, 13, and 14° C., including all ranges and subranges therein.

The neutralization time, which is variable depending on the alkali treatment time, is usually 10 minutes to 2 hours, preferably 30 minutes to 1 hour. The neutralization time may be 15 minutes, 20 minutes, 40 minutes, 50 minutes and 1.5 hours. After the neutralization, pH of water on the surface of the fish eggs or milt may be in a weakly acidic range.

After the washing with water or the neutralization treatment, the fresh fish eggs or milt are put on the market as they are or they are processed by ordinary methods for producing Sujiko or Ikura. Thus, treated eggs or milt can be further processed with various seasonings.

The present invention is explained in more detail with the aid of the following embodiment examples.

### EXAMPLES

### Example

An alkaline treating solution having the following composition was prepared:

| | |
|---|---|
| Sodium acetate (buffer) | 38% by mass |
| Calcium oxide (alkali) | 30% by mass |
| Glucose (penetrant) | 32% by mass |

10 g of the alkaline was dissolved in water to produce 1,000 ml of an aqueous alkali solution having a calcium oxide content of 0.3% by mass and pH of 11.

Hard roes, in which almost all fish eggs were separated from one another, were taken out of the ventral side of each beech salmon caught at Hokkaido in November. The salmon eggs were washed with water to remove stains such as the blood and mucus therefrom. Immediately thereafter, they were put in the above-described aqueous alkali solution of about 5° C. and kept therein under stirring for 40 minutes. The fish eggs were taken, washed with running water and then washed with 2,000 ml of water of about 5° C. for 40 minutes. The fish eggs were put in saturated aqueous sodium chloride solution and immersed therein under occasional stirring for about 10 to 20 minutes. After draining, the fish eggs were stored at about 4° C. in a refrigerator.

The membrane covering each egg was further thinned by the treatment with the aqueous alkali solution and thus softened Ikura were obtained. After storing the resultant Ikura at 5° C. in a refrigerator for 3 weeks, the eggs were not broken and the appearance thereof was in no way inferior to that of ordinary Ikura. Although the salmon egg materials had no commercial value before the above application, it became possible to put them on the market after the treatment as ordinary Ikura.

### Comparative Example 1

In Comparative Example 1, the same procedure as that of Example 1 was repeated except that the treatment with the aqueous alkali solution and the subsequent washing with water to remove the aqueous alkali solution were omitted. Ikura obtained in Comparative Example 1 was elastic like “Ping-Pong balls” and very difficult to be chewed. After keeping Ikura at 5° C. in a refrigerator for about 5 days, the membranes of them were broken, they were deformed, the fluid in the eggs started to flow out and the dripping gradually became serious. About 10 days thereafter, almost all the eggs dripped and they had no commercial value.

In addition, it was found that dents and wrinkles on the eggs in the hard roes in an early stage can be removed by the treatment of the present invention to obtain eggs having the tensional membrane.

### Example 2

The same procedure as that of Example 1 was repeated except that the hard roes were taken out of the ventral side of each of a fresh salmon obtained in September and then washed with clean water in a short period of time to remove stains such as the blood and mucus therefrom. The fresh hard roes were arranged on a drainboard to drain them and then preserved in salt by Furishio-zuke (e.g. Tanazuke Method) to produce the salted roes (e.g. Sujiko). The resultant Sujiko could be kept from the dripping during the tasting time of 20 days. While the period of tasting time of ordinary Sujiko produced without the treatment was 7 days, that of the present invention was remarkably elongated.

In light of the above, it is clear that the tasting time or commercial value of fish eggs or milt can be remarkably increased by treating fish eggs or milt with an aqueous alkali solution and then washing off or neutralizing the aqueous alkali solution remaining on the treated fish eggs or milt. When the milt is treated according to the present invention, the tasting time of the elastic, fresh milt can be remarkably elongated, while the tasting time of the ordinary milt was only about 2 days. Further, hard roes or fish eggs of salmons or the like caught after the harvest season and regarded to be commercially valueless in the past can be changed to commercially valuable fresh fish egg products.

What is claimed is:

1. A process for producing a fresh fish egg product or a milt product, comprising
treating at least one fresh fish egg or milt with an aqueous alkali solution; and
washing off or neutralizing the aqueous alkali solution on the treated at least one fish egg or milt.

2. The process according to claim 1, wherein the at least one fresh fish egg is from at least one fish selected from the group consisting of salmon, trout, herring, codfish, mullet, flying fish and globefish.

3. The process according to claim 1, further comprising
dissolving an alkali in water to produce the aqueous alkali solution.

4. The process according to claim 3, wherein said alkali is at least one member selected from the group consisting of calcium oxide, sodium hydroxide, potassium hydroxide, calcium hydroxide, disodium hydrogenphosphate, sodium phosphate, dipotassium hydrogenphosphate, potassium phosphate, diammonium hydrogenphosphate, sodium polyphosphate, potassium polyphosphate, calcium phosphate, magnesium carbonate, ammonium carbonate, sodium carbonate, potassium carbonate, calcium carbonate, sodium hydrogencarbonate and potassium hydrogencarbonate.

5. The process according to claim 1, wherein said aqueous alkali solution has a pH of 7.5 to 13.0.

6. The process according to claim 1, wherein said aqueous alkali solution has a pH of 8.5 to 13.0.

7. The process according to claim 1, wherein said aqueous alkali solution has a pH of 9.5 to 12.0.

8. The process according to claim 1, wherein the treating time is from 1 minute to 24 hours.

9. The process according to claim 1, wherein the treatment temperature is from 0 to 10° C.

10. The process according to claim 1, wherein the washing time is from 1 minute to 24 hours.

11. The process according to claim 1, wherein the washing is performed with water or salt water.

12. A fresh fish egg product or a milt product made by the process according to claim 1.

13. The product according to claim 12, wherein said at least one fresh fish egg is from at least one fish selected from the group consisting of salmon, trout, herring, codfish, mullet, flying fish and globefish.

14. A fresh fish egg product or a milt product made by the process according to claim 3.

15. The product according to claim 14, wherein said alkali is at least one member selected from the group consisting of calcium oxide, sodium hydroxide, potassium hydroxide, calcium hydroxide, disodium hydrogenphosphate, sodium phosphate, dipotassium hydrogenphosphate, potassium phosphate, diammonium hydrogenphosphate, sodium polyphosphate, potassium polyphosphate, calcium phosphate, magnesium carbonate, ammonium carbonate, sodium carbonate, potassium carbonate, calcium carbonate, sodium hydrogencarbonate and potassium hydrogencarbonate.

16. The product according to claim 12, wherein said aqueous alkali solution has a pH of 7.5 to 13.0.

17. The product according to claim 12, wherein said aqueous alkali solution has a pH of 8.5 to 13.0.

18. The product according to claim 12, wherein said aqueous alkali solution has a pH of 9.5 to 12.0.

19. The product according to claim 12, wherein said product is at least one salted egg of salmon.

20. The product according to claim 12, wherein said product is at least one salted hard roe of salmon.
